(19) United States
(12) Patent Application Publication
(10) Pub. No.: US 2018/0098390 A1
(43) Pub. Date: Apr. 5, 2018

(54) DETECTING APPARATUS AND HEATING APPARATUS

(71) Applicant: FUJITSU LIMITED, Kawasaki-shi (JP)

(72) Inventors: Yohei Yagishita, Isehara (JP); Yoichi Kawano, Setagaya (JP)

(73) Assignee: FUJITSU LIMITED, Kawasaki-shi (JP)

(21) Appl. No.: 15/702,866

(22) Filed: Sep. 13, 2017

(30) Foreign Application Priority Data
Sep. 30, 2016 (JP) 2016-194966

(51) Int. Cl. H05B 6/64; G01N 22/04; H05B 6/68; H05B 6/70

(52) U.S. Cl. CPC H05B 6/6447; H05B 6/705; H05B 6/68; G01N 22/04

(57) ABSTRACT

A detecting apparatus includes a plurality of first emitting parts two-dimensionally disposed, in a first axial direction with respect to an arrangement position at which a target object to which millimeter waves are to be emitted is arranged, to be directed to the arrangement position, the plurality of first emitting parts being configured to emit millimeter waves having a wavelength that is absorbed or reflected by a specific substance included in the target object; a first receiving part two-dimensionally disposed to face the plurality of first emitting parts across the arrangement position and to be directed to the arrangement position, the first receiving part being configured to receive the millimeter waves; and a first detecting part configured to detect a two-dimensional intensity distribution of the millimeter waves received by the first receiving part.

### CROSS-REFERENCE TO RELATED APPLICATION

This application is based upon and claims the benefit of priority of the prior Japanese Patent Application No. 2016-194966, filed on Sep. 30, 2016, the entire contents of which are incorporated herein by reference.

### FIELD

The embodiments discussed herein relate to a detecting apparatus and a heating apparatus.

### BACKGROUND

A freezing/unfreezing apparatus that includes a cooling/heat-radiating unit that cools or radiates heat from a water-containing substance, a millimeter wave irradiating apparatus that irradiates the water-containing substance with a millimeter wave of 0.1 mm to 100 mm, and a millimeter wave detecting apparatus that detects the millimeter wave that has passed through the water-containing substance is known in the related art. Further, the freezing/unfreezing apparatus further includes a phase change detecting apparatus that calculates, from irradiation output and detection output of the millimeter wave, an amount of absorption of the water-containing substance to detect a phase change of the water-containing substance, and a control apparatus that controls the freezing/unfreezing apparatus based on the detected phase change (for example, see Patent Document 1).

However, amounts of water inside an object to be heated (unfrozen) by the cooling/unfreezing apparatus are not uniform and a distribution of the amounts of water differs depending on a type of an object to be heated.

However, the above freezing/unfreezing apparatus does not detect a distribution of phase change in a horizontal direction or a vertical direction with respect to the emitting direction of the millimeter wave detecting apparatus.

Therefore, it is difficult for the above freezing/unfreezing apparatus to detect the distribution of phase change of the object to be heated and to uniformly unfreeze the object. That is, because a distribution of amounts of heat required in an object to be heated cannot be detected, it is to uniformly unfreeze the object.

Further, in a case where an object to be heated is a substance that does not include water, it is difficult to detect a substance distribution. Therefore, a distribution of amounts of heat required in the object to be heated cannot be detected, and it is to uniformly unfreeze the object.

### RELATED-ART DOCUMENTS

### Patent Documents

[Patent Document 1] Japanese Laid-open Patent Publication No. 2006-017418

### SUMMARY

According to an aspect of an embodiment, a detecting apparatus includes a plurality of first emitting parts two-dimensionally disposed, in a first axial direction with respect to an arrangement position at which a target object to which millimeter waves are to be emitted is arranged, to be directed to the arrangement position, the plurality of first emitting parts being configured to emit millimeter waves having a wavelength that is absorbed or reflected by a specific substance included in the target object; a first receiving part two-dimensionally disposed to face the plurality of first emitting parts across the arrangement position and to be directed to the arrangement position, the first receiving part being configured to receive the millimeter waves; and a first detecting part configured to detect a two-dimensional intensity distribution of the millimeter waves received by the first receiving part.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a plan view illustrating a heating apparatus according to a first embodiment;

FIG. 2 is a diagram illustrating a PAR 110X;

FIG. 3 is a diagram illustrating a receiving array 120X;

FIG. 4 is a diagram illustrating a microwave generator 130;

FIG. 5 is a diagram illustrating an example of intensity distributions of millimeter waves received by the receiving arrays 120X and 120Z;

FIG. 6 is a diagram for describing intensities and phases of microwaves emitted from the microwave generators 130;

FIG. 7 is a diagram illustrating a flowchart of the heating apparatus 100;

FIG. 8 is a diagram illustrating a heating apparatus 200 according to a second embodiment;

FIG. 9 is a diagram illustrating an operation control system including an information processing apparatus 500 of a data center;

FIG. 10 is a block diagram illustrating a configuration of the information processing apparatus 500;

FIG. 11 is a block diagram illustrating a configuration of an ECU 300;

FIG. 12 is a flowchart illustrating a process that is executed by the information processing apparatus 500; and

FIG. 13 is a flowchart illustrating a process that is executed by the ECU 300.

### DESCRIPTION OF EMBODIMENT

Hereinafter, embodiments will be described to which a detecting apparatus and a heating apparatus of the present invention are applied. One aspect of the embodiment is to provide a detecting apparatus and a heating apparatus that can detect a distribution of amounts of heat required in a target object to be heated.

### First Embodiment

FIG. is a plan view illustrating a heating apparatus 100 according to a first embodiment. A detecting apparatus according to the first embodiment is included in the heating apparatus 100. In the following descriptions, an XYZ coordinate system is defined.

The heating apparatus 100 includes a heat chamber 101, a stage 102, Phased Array Radars (referred to as the “PARs” hereinafter) 110X and 110Y, receiving arrays 120X and 120Z, microwave generators 130, and a controlling part 140. According to the first embodiment, the heating apparatus 100 is a called microwave oven.

Among the PARs 110X and 110Y, the receiving arrays 120X and 120Z, and the controlling part 140, part relating to control of the PARs 110X and 110Y and the receiving arrays 120X and 120Z constitutes a detecting apparatus according to the first embodiment.

The heat chamber 101 is a space in which heating a process of heating is performed, and is covered by a reflection wall 101A that reflects microwaves. The stage 102 is arranged at the center of the heat chamber 101, and the PARs 110X and 110Z, the receiving arrays 120X and 120Z, and the microwave generators 130 are disposed around the heat chamber 101. A target object 103 to be heated is mounted on the stage 102.

The PAR 110X is located at a negative side in the X axis direction of the heat chamber 101. The PAR 110X is arranged to emit millimeter waves, in the positive side in the X axis direction, into the heat chamber 101. A plurality of arrayed radar emitting parts included in the PAR 110X are disposed along the Y axis direction, and disposed along the Z axis direction. That is, the radar emitting parts of the PAR 110X are arrayed in a matrix. The plurality of radar emitting parts of the PAR 110X is an example of first emitting parts.

The PAR 110X can scan (change) an emitting direction with respect to the X axis horizontally (in a direction making an angle with respect to the X axis within an XZ plane) and vertically (in a direction making an angle with respect to the X axis within an XY plane) by adjusting the phases of millimeter waves emitted from the plurality of radar emitting parts arrayed in the matrix. Scanning the angle and emitting the millimeter waves of the PAR 110X are controlled by the controlling part 140.

For example, each of the radar emitting parts of the PAR 110X emits a millimeter wave at a frequency of 22 GHz. The millimeter wave of 22 GHz has a quality of being absorbed by unfrozen (defrosted) water but of not being easily absorbed by frozen water. With respect to the millimeter wave of 22 GHz, transmittance of frozen water is higher than transmittance of unfrozen water. It should be noted that the target object 103 to be heated may include a specific substance that absorbs of reflect a millimeter wave having a predetermined wavelength emitted from each of emitting parts of the PARs 110X and 100Z.

The radar emitting parts are patch antennas, for example. The patch antennas of the PAR 110X are provided at a central portion of the refection wall 101A at the negative side in the X axis direction of the heat chamber 101. In order to reflect microwaves and to transmit the millimeter waves radiated from the patch antennas, a plurality of openings whose sizes correspond to a wavelength of the millimeter waves are formed on the reflection wall 101A at the negative side in the X axis direction, and the patch antennas are arranged in the back of the respective openings.

The PAR 110Z is located at a negative side in the Z axis direction of the heat chamber 101. The PAR 110Z is arranged to emit millimeter waves, in the positive side in the Z axis direction, into the heat chamber 101. A configuration of the PAR 110Z is similar to that of the PAR 110X. The PAR 110Z includes a plurality of radar emitting parts arrayed in a matrix along an XY plane. For example, each of the radar emitting parts of the PAR 110Z emits a millimeter wave at a frequency of 22 GHz. The plurality of radar emitting parts of the PAR 110Z is an example of second emitting parts.

The PAR 110X can scan (change) an emitting direction with respect to the Z axis horizontally (in a direction making an angle with respect to the Z axis within an XZ plane) and vertically (in a direction making an angle with respect to the Z axis within an YZ plane) by adjusting the phases of millimeter waves emitted from the plurality of radar emitting parts arrayed in the matrix. Scanning the angle and emitting the millimeter waves of the PAR 1102 are controlled by the controlling part 140.

Similar to the PAR 110X, the radar emitting parts of the PAR 110Z may be patch antennas, for example. The patch antennas of the PAR 110Z are provided at a central portion of the refection wall 101A at the negative side in the Z axis direction of the heat chamber 101. A configuration of the reflection wall 101A at the negative side in the Z axis direction is similar to the configuration of the reflection wall 101A at the negative side in the X axis direction.

The receiving array 120X is disposed, at the positive side in the X axis direction of the heat chamber 101, to face the PAR 110X across the position at which the target object 103 to be heated is arranged. The receiving array 120X includes a plurality of patch antennas arranged in a matrix along an YZ plane, and receives the millimeter waves emitted from the PAR 110X. The plurality of patch antennas of the receiving array 120X are an example of a first receiving part.

The plurality of patch antennas are provided substantially entirely on the reflection wall 101A at the positive side in the X axis direction of the heat chamber 101. In order to reflect the microwaves and to transmit the millimeter waves to the plurality of patch antennas, a plurality of openings whose sizes correspond to a wavelength of the millimeter waves are provided on the reflection wall 101A at the positive side in the X axis direction, and the patch antennas are arranged in the back of the respective openings. Signals that represent intensities of the millimeter waves received by the patch antennas of the receiving array 120X are input to the controlling part 140.

The receiving array 120Z is disposed, at the positive side in the Z axis direction of the heat chamber 101, to face the PAR 110Z across the position at which the target object 103 to be heated is arranged. The receiving array 120Z includes a plurality of patch antennas arranged in a matrix along an XY plane, and receives the millimeter waves emitted from the PAR 110Z. The size of each patch antenna corresponds to the millimeter wave of 22 GHz. The plurality of patch antennas of the receiving array 120Z are an example of a second receiving part.

The plurality of patch antennas are provided substantially entirely on the reflection wall 101A at the positive side in the Z axis direction of the heat chamber 101. In order to reflect the microwaves and to transmit the millimeter waves to the plurality of patch antennas, a plurality of openings whose sizes correspond to a wavelength of the millimeter waves are provided on the reflection wall 101A at the positive side in the Z axis direction, and the patch antennas are arranged in the back of the respective openings. Signals that represent intensities of the millimeter waves received by the patch antennas of the receiving array 120Z are input to the controlling part 140.

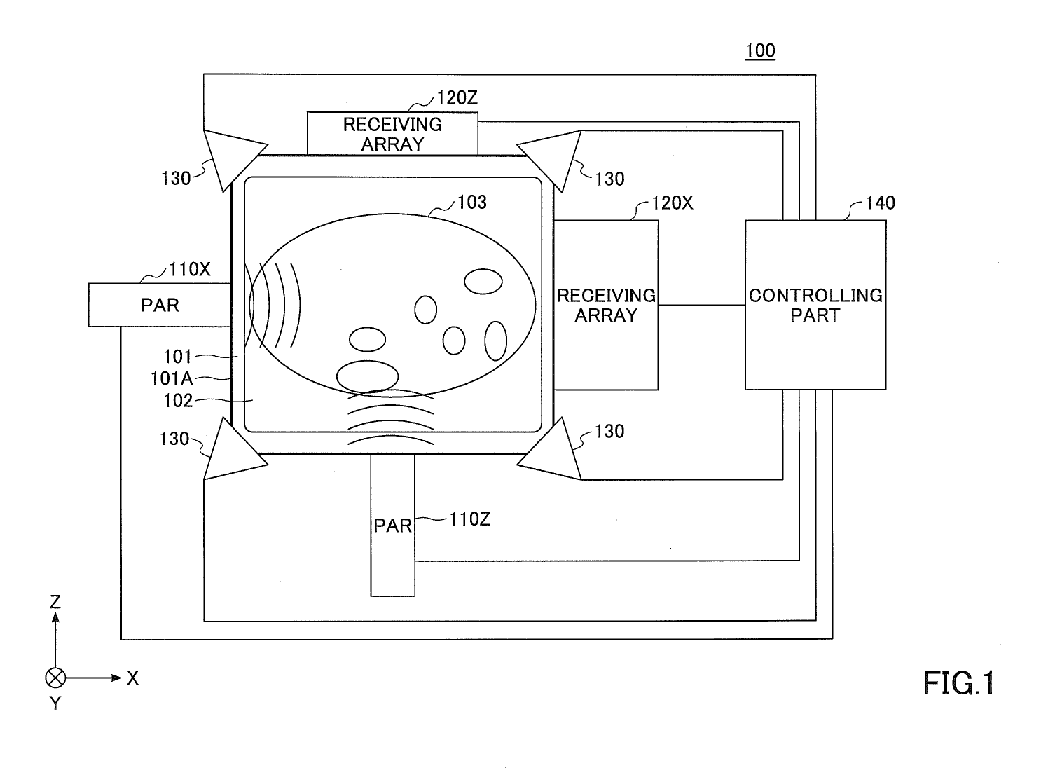

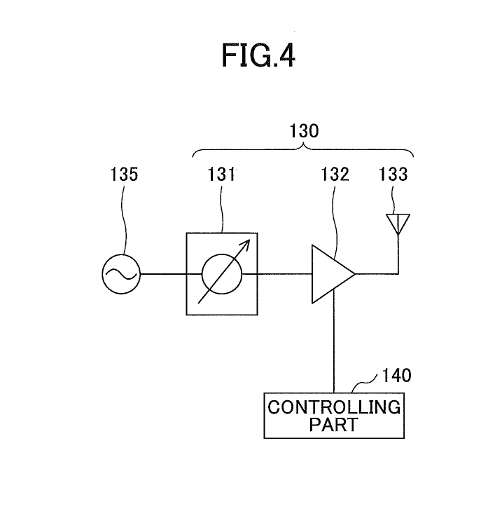

The microwave generators 130 are provided on the four corners of the heat chamber 101. Although the four microwave generators 130 are illustrated in FIG. 1, two microwave generators 130 (one for the upper side and one for the lower side in the Y axis direction) may be provided for each of the four corners of the heat chamber 101. In this case, the eight microwave generators 130 are present. Each of the microwave generators 130 is controlled by the controlling part 140. Each of the microwave generators 130 includes an antenna, an amplifier, and a radiofrequency source (oscillator). A configuration of the microwave generators 130 will be described later below with reference to FIG. 4.

The controlling part 140 controls the PARs 110X and 110Z to scan the millimeter waves, and controls driving of the respective microwave generators 130 based on an intensity distribution of the millimeter waves received by the receiving arrays 120X and 120Z. The controlling part 140 is a controlling part of a microwave open, and is realized by a computer including a Central Processing Unit (CPU) chip. The controlling part 140 is an example of a first detecting part, a second detecting part, and an output controlling part.

The controlling part 140 detects, from the intensity distribution of the millimeter waves received by the receiving array 120X, a distribution of a frozen portion and an unfrozen portion of the target object 103 to be heated in a YZ plane. Further, the controlling part 140 detects, from the intensity distribution of the millimeter waves received by the receiving array 120Z, a distribution of a frozen portion and an unfrozen portion of the target object 103 to be heated in a XY plane.

In this way, the controlling part 140 can detect, based on the distribution of the frozen portion and the unfrozen portion of the target object 103 to be heated in the YZ plane and based on the distribution of the frozen portion and the unfrozen portion of the target object 103 to be heated in the YZ plane, a three-dimensional distribution of the frozen portion and the unfrozen portion of the target object 103 to be heated.

Based on the three-dimensional distribution of the frozen portion and the unfrozen portion of the target object 103 to be heated, the controlling part 140 controls driving of the respective microwave generators 130 such that the intensity of the microwave(s) emitted to the frozen portion increases and the intensity of the microwave(s) emitted to the unfrozen portion decreases.

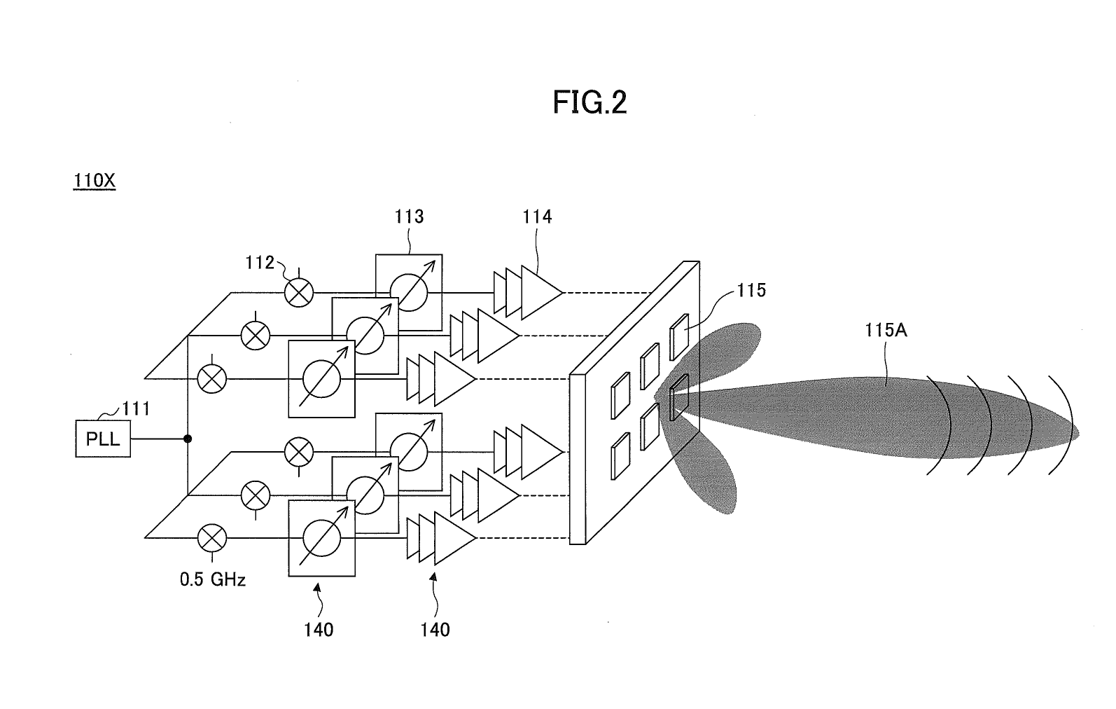

FIG. 2 is a diagram illustrating the PAR 110X. Note that only the PAR 110X will be described here because a configuration of the PAR 1102 is similar to that of the PAR 110X.

The PAR 110X includes a Phase Locked Loop (PLL) 111, multipliers 112, phase adjusters 113, amplifiers 114, and patch antennas 115. The PLL 111 outputs, to the respective multipliers 112, millimeter waves of 22 GHz. The plurality of multipliers 112, the phase adjusters 113, the amplifiers 114, the patch antennas 115 are coupled in parallel to the output side of the PLL 111.

The millimeter waves of 22 GHz output from the PLL 111 and signals of 0.5 GHz are input to the respective multipliers 112. The respective multipliers 112 output, to the phase adjusters 113, millimeter waves obtained by multiplying the millimeter waves of 22 GHz by the signals of 0.5 GHz. The signals of 0.5 GHz are used to detect phases, and may be supplied from another PLL or the like, which is different from the PLL 111.

The phase adjusters 113 adjust the phases of the millimeter waves output from the respective multipliers 112. The phases of the millimeter waves are adjusted by the phase adjusters 113 to scan the millimeter waves by the PAR 110X. The respective amplifiers 114 amplify the millimeter waves output from the phase adjusters 113, and output the amplified waves to the patch antennas 115. The amplifiers 114 are power amplifiers that amplify the respective millimeter waves output from the phase adjusters 113. The patch antennas 115 are the patch antennas for the PAR 110X described above, and are provided on a central portion of the reflection wall 101A at the negative side in the X axis direction of the heat chamber 101.

The phase amounts in the phase adjusters 113 and the amplification degrees of the amplifiers 114 are controlled by the controlling part 140 to output millimeter waves 115A from the PAR 110X. The emitting direction of the millimeter waves 115A can be scanned (changed) with respect to the Z axis horizontally (in a direction making an angle with respect to the Z axis within an XZ plane) and vertically (in a direction making an angle with respect to the Z axis within an YZ plane).

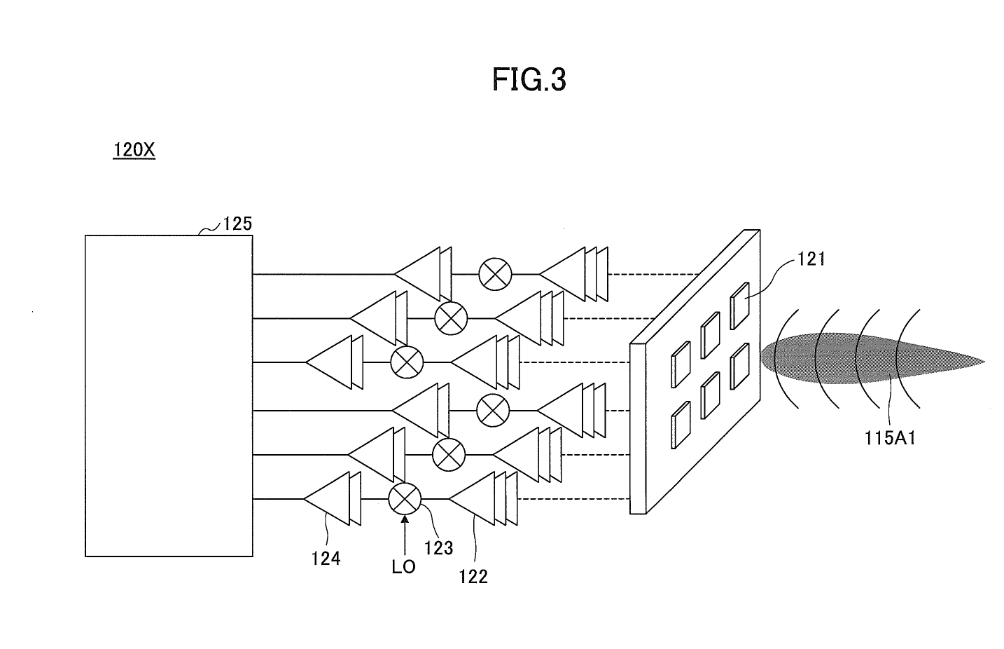

FIG. 3 is a diagram illustrating the receiving array 120X. Note that only the receiving array 120X will be described here because a configuration of the receiving array 120Z is similar to that of the receiving array 120X.

The receiving array 120X includes patch antennas 121, Low Noise Amplifiers (LNAs) 122, multipliers 123, Interface amplifiers 124, and a signal processing part 125.

The patch antennas 121 are the patch antennas for the receiving array 120X described above, and provided on the reflection wall 101A at the positive side in the X axis direction of the heat chamber 101. The LNAs 122, the multipliers 123, and the IF amplifiers 124 are coupled in series to the respective patch antennas 121. The outputs of the respective IF amplifiers 124 are input to the controlling part 140 via the signal processing part 125.

The patch antennas 121 receive millimeter waves 115A1 that have passed through the target object 103 to be heated, and output the millimeter waves 115Aa to the LNAs 122. The LNAs 122 remove noise of the millimeter waves and amplify the millimeter wave, to output the waves to the multipliers 123.

The multipliers 123 multiply the respective outputs (the millimeter waves) of the LNA 122 by local signals LO to output, to the IF amplifiers 124, signals that represent phase differences of the outputs (the millimeter waves) of the LNAs 122 with respect to the local signals LO. The local signals LO are signals that represent phases of the millimeter waves output from the PLL 111. The signals, which represent the phase differences, are input to the signal processing part 125 via the IF amplifiers 124, and thereafter input to the controlling part 140. As a result, the controlling part 140 can detect the phases and the signal levels of the millimeter waves received by the respective patch antennas 121. Note that the signal processing part 125 may be provided inside the controlling part 140.

FIG. 4 is a diagram illustrating the microwave generator 130. A configuration of one microwave generator 130 will be described here because each of the microwave generators 130 has a similar or same configuration.

The microwave generator 130 includes a phase adjuster 131, an amplifier 132, and an antenna 133. The phase adjuster 131 is coupled to an oscillator 135 that generates a microwave. For example, the oscillator 135 oscillates the microwave of 2.45 GHz. The phase adjuster 131 adjusts the phase of the microwave to output the adjusted microwave to the amplifier 132.

The amplifier 132 may be any type of amplifier that can amplify the microwave output from the phase adjuster 131. Here, an amplifier including a transistor made of gallium nitride (GaN) semiconductor may be used as an example.

This is because an amplifier including a transistor made of gallium nitride (GaN) has a very high amplification factor and can efficiently amplify the microwave output from the oscillator 135. Here, a GaN-HEMT (High Electron Mobility Transistor) is an example of the transistor made of gallium nitride (GaN).

The antenna 133 is a horn antenna or a patch antenna. The antenna 133 is provided on the reflection wall 101A of the heat chamber 101, and emits the microwave output from the amplifier 132.

The amount of phase of the microwave adjusted by the phase adjuster 131 and the factor of amplification of in the amplifier 132 are controlled by the controlling part 140. The microwave generator 130 causes the phase adjuster 131 to adjust the phase of the microwave oscillated from the oscillator 135, causes the amplifier 132 to amplify the adjusted microwave, and radiates the amplified microwave to the heat chamber 101.

In a case where the heating apparatus 100 includes eight microwave generators 130, eight antennas 133 are disposed on the heat chamber 101.

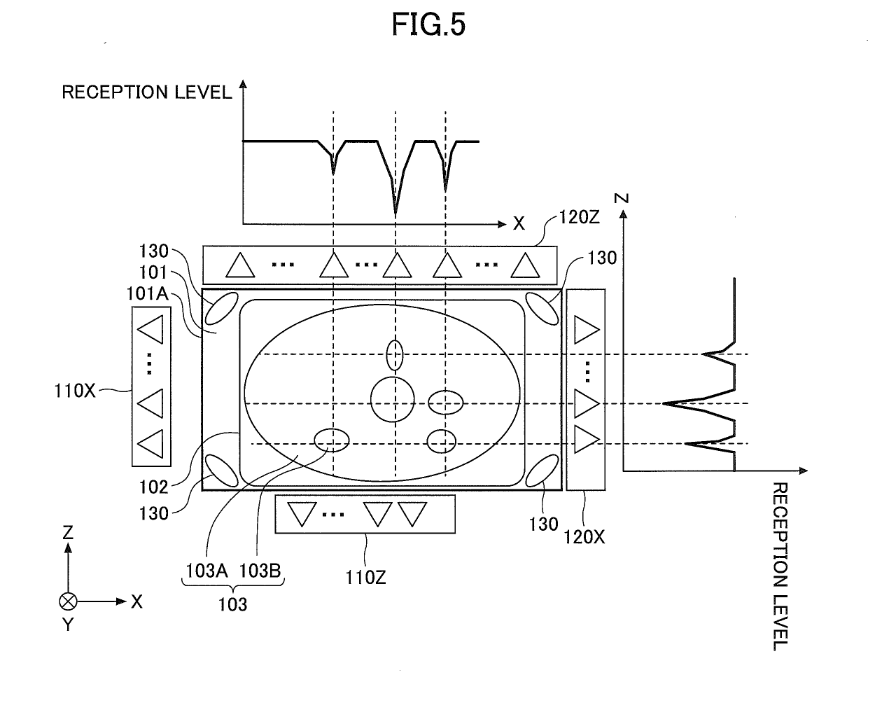

FIG. 5 is a diagram illustrating an example of an intensity distribution of millimeter waves received by the receiving arrays 120X and 120Z. The controlling part 140 is omitted in FIG. 5. FIG. 5 illustrates the plurality of radar emitting parts of the PARs 110X and 110Z, the plurality of patch antennas of the receiving arrays 120X and 120Z. Further, FIG. 5 illustrates the frozen portion 103A and the unfrozen portions 103B of the target object 103 to be heated.

Further, FIG. 5 illustrates the distribution of the reception levels of the millimeter waves received by the receiving array 120X and the distribution of the reception levels of the millimeter waves received by the receiving array 120Z. The distribution of the reception levels of the millimeter waves received by the receiving array 120X is a distribution of the reception levels in the Z axis direction at a predetermined position in the Y axis direction. Such a distribution can be obtained by scanning, at a predetermined position in the Y axis direction, the millimeter waves emitted from the PAR 110X from the negative side end in the Z axis direction to the positive side end in the Z axis direction of the heat chamber 101.

Further, the distribution of the reception levels of the millimeter waves received by the receiving array 120Z is a distribution of the reception levels in the X axis direction at a predetermined position in the Y axis direction. The reception levels indicate voltages of the millimeter waves received by the receiving arrays 120X and 120Z. Such a distribution can be obtained by scanning, at a predetermined position in the Y axis direction, the millimeter waves emitted from the PAR 110Z from the negative side end in the X axis direction to the positive side end in the X axis direction of the heat chamber 101.

As illustrated in FIG. 5, with respect to the predetermined position in the Y axis direction, the reception level of the millimeter wave received by the receiving array 120X is low at a position where the frozen portion 103A is present in the Z axis direction, and the reception level of the millimeter wave received by the receiving array 120X is high at a position where the unfrozen portion 103B is present in the Z axis direction. Further, with respect to the predetermined position in the Y axis direction, the reception level of the millimeter wave received by the receiving array 120Z is low at a position where the frozen portion 103A is present in the Y axis direction, and the reception level of the millimeter wave received by the receiving array 120Z is high at a position where the unfrozen portion 103B is present in the Z axis direction.

By obtaining, in the Y axis direction from the lower end to the upper end of the heat chamber 101, the reception levels of the millimeter waves received by the receiving arrays 120X and 120Z, a three-dimensional distribution of the frozen portion(s) 103A and the unfrozen portion(s) 103B of the target object 103 to be heated can be obtained. The distribution of the reception levels from the lower end to the upper end of the heat chamber 101 in the Y axis direction can be obtained by scanning the millimeter waves emitted from the PARs 110X and 110Z in the Y axis direction.

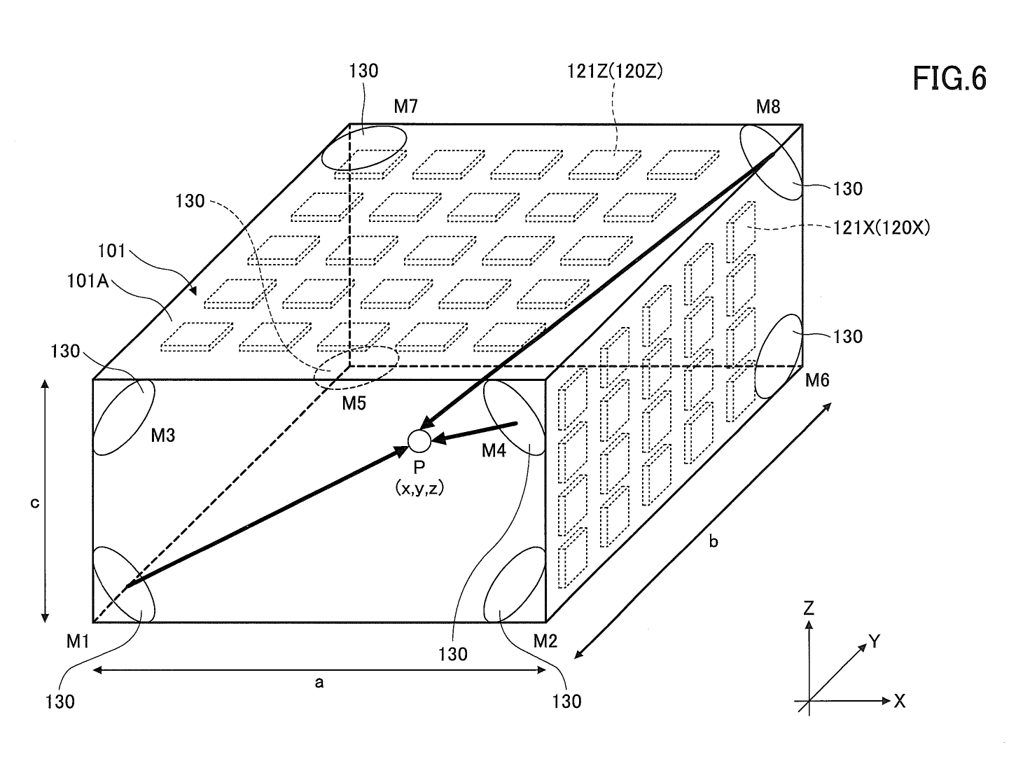

FIG. 6 is a diagram for describing intensities and phases of microwaves emitted from the microwave generators 130. FIG. 6 illustrates the patch antennas 121X of the receiving array 120X and the patch antennas 121Z of the receiving array 120Z. Further, the eight microwave generators 130, which are arranged at eight corners of the heat chamber 101, are referred to as microwave generators M1 to M8 to distinguish them.

Here, the twenty patch antennas 121X are arrayed on the reflection wall 101A at the positive side in the X axis direction (5 rows in the Y axis direction×4 columns in the Z axis direction). The twenty five patch antennas 121Z are arrayed on the reflection wall 101A at the positive side in the Z axis direction (5 rows in the X axis direction×5 columns in the Y axis direction). Note that these numbers of patch antennas are an example.

Here, it is assumed that the dimension of the heat chamber 101 in the X axis direction is “a”, the dimension of the heat chamber 101 in the Y axis direction is “b”, and the dimension of the heat chamber 101 in the Z axis direction is “c”. Further, the corner of the heat chamber 101 at which the microwave generator 101 is arranged is defined as an origin of the XYZ coordinate system.

The coordinates of the microwave generators M1 to M8 are respectively M1 (0,0,0), M2 (a,0,0), M3 (0,0,c), M4 (a,0,c), M5 (0,b,0), M6 (a,b,0), M7 (0,b,c), and M8 (a,b,c). A point (X,Y,Z) within the heat chamber 101 will be discussed.

When the microwave emitted from the microwave generator M1 resonates at the point P (X,Y,Z), the electric field (X,Y,Z) and the phase φ1 are respectively represented by the following formulas (1) and (2).

E(x,y,z)=Aexp{j(kx+ky+kz)} (1)

φ1=kx+ky+kz (2)

Here, k is a wave number, and is determined depending on a frequency and a medium that the microwave (electromagnetic wave) passes through.

In this case, when the microwave emitted from the microwave generator M8 resonates at the point P (X,Y,Z), the electric field and the phase φ8 are respectively represented by the following formulas (3) and (4). Note that the coordinates (X′,Y′,Z′) are coordinates when the corner of the heat chamber 101 at which the microwave generator M8 is present is defined as the origin.

E(x′,y′,z′)=Aexp{j(kx′+ky′+kz′)} (3)

φ8=kx′+ky′+kz′ (4)

When both phase differences are equal to each other at the point P (X,Y,Z), the microwave emitted from the microwave generator M1 and the microwave emitted from the microwave generator M8 are strengthened with each other to generate resonance.

Because the coordinates (x,y,z) are not always equal to the coordinates (x′,y′,z′), the phase differences does not necessarily equal to each other. In a case where the phase of the microwave generator M8 is shifted by using the phase shifter 131, resonant conditions are represented by the following formulas (5) and (6). Note that θ in the formula (6) is a phase difference between the microwave emitted from the microwave generator M1 and the microwave emitted from the microwave generator M8.

φ1=kx+ky+kz (5)

k(x+y+z)=k(x′+y′+z′)+θ (6)

Here, a relationship between the coordinates (X,Y,Z) and the coordinates (X′,Y′,Z′) is represented by the following formula (7).

x′=a−x

y′=b−y

z′=c−z (7)

When the formulas (6) and (7) are arranged, a phase difference θ81 of the microwave emitted from the microwave generator M8 with respect to the microwave emitted from the microwave generator M1 is represented by the following formula (8).

θ81=2k(x+y+z)−k(a+b+c) (8)

That is, when the phase the phase of the microwave emitted from the microwave generator M8 is shifted, with respect to the microwave emitted from the microwave generator M1, by the phase difference θ81 the represented by the formula (8) by using the phase shifter 131 of the microwave generator M8, the microwave emitted from the microwave generator M1 and the microwave emitted from the microwave generator M8 resonate at the point P (X,Y,Z). The resonant conditions are determined depending on the position of the microwave generator M8 relative to the microwave generator M1.

Accordingly, for the microwaves emitted from the microwave generators M2 to M7, phase differences θ21 to θ71 from the microwave emitted from the microwave generator M1 may be set as the following formulas (9).

θ21=2k(x+y+z)−ka

θ31=2k(x+y+z)−kc

θ41=2k(x+y+z)−k(a+c)

θ51=2k(x+y+z)−kb

θ61=2k(x+y+z)−k(a+b)

θ71=2k(x+y+z)−k(b+c) (9)

Note that the phase difference θ21 is a phase difference of the microwave emitted from the microwave generator M2 with respect to the microwave emitted from the microwave generator M1. This is similarly applied to the microwave generators M3 to M7, and the phase difference θ71 is a phase difference of the microwave emitted from the microwave generator M7 with respect to the microwave emitted from the microwave generator M1.

As described above, the phase differences θ21 to θ81 of the electric fields of the microwaves emitted from the microwave generators M2 to M8 to the point P (X,Y,Z) are obtained. The phase differences θ21 to θ81 are phase differences with respect to the electric field of the microwave emitted from the microwave generator M1 to the point P (X,Y,Z).

Here, when the phases of the microwaves emitted from the microwave generators M1 to M8 to the point P (X,Y,X) are a, the electric field intensities EM1 to EM8 of the microwaves emitted from the microwave generators M1 to M8 to the point P (X,Y,X) can be represented by the following formulas (10). Here, AM1 to AM8 are amplitudes of the microwaves emitted from the microwave generators M1 to M8. The respective amplitudes are set by the amplifiers 132 of the microwave generators M1 to M8.

EM1=AM1exp(jα)

EM2=AM2exp(jα)

EM3=AM3exp(jα)

EM4=AM4exp(jα)

EM5=AM5exp(jα)

EM6=AM6exp(jα)

EM7=AM7exp(jα)

EM8=AM8exp(jα) (10)

Because the eight electric fields represented by the formulas (10) are strengthened at the point P (X,Y,Z), an electric field intensity at the point P (X,Y,Z) can be represented by the following formula (11).

Eall=Σₙ₌₁⁸EMn=Σₙ₌₁⁸AMnexp(jα) (11)

Accordingly, based on a three-dimensional distribution of the frozen portion 103A and the unfrozen portion 103B of the target object 103 to be heated, the respective microwave generators 130 may be controlled to be driven such that the intensity of the microwave emitted to the frozen portion 103A increases and the intensity of the microwave emitted to the unfrozen portion 103B decreases.

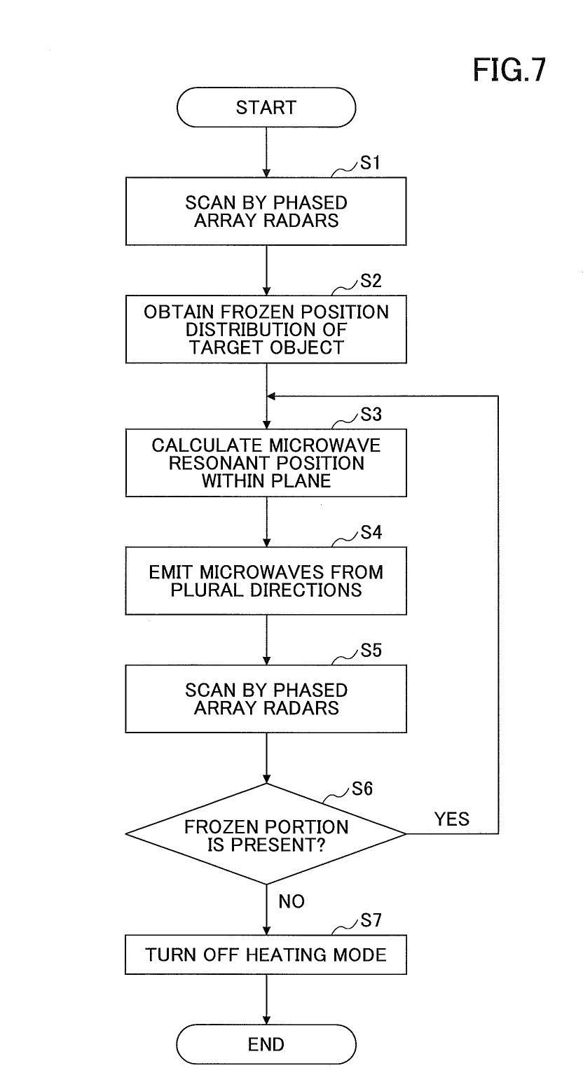

FIG. 7 is a flowchart illustrating a process of the heating apparatus 100. The process illustrated in FIG. 7 is executed by the controlling part 140.

Upon a start button of the heating apparatus 100 being pushed, the controlling part 140 starts the process to cause the PARs 110X and 110Z to emit millimeter waves and to scan their angles in step S1. At this time, the target object 103 to be heated is placed on the stage 102.

The controlling part 140 obtains an intensity distribution of the millimeter waves from the receiving arrays 120X and 120Z in step S2. The obtained intensity distribution of the millimeter waves represents a three-dimensional distribution of a frozen portion 103A and an unfrozen portion 103B of the target object 103 to be heated.

The controlling part 140 calculates, based on the three-dimensional distribution obtained in step S3, an electric field intensity of the microwaves in step S3. Specifically, the controlling part 140 calculates the electric field at the point P (X,Y,Z) by the formula (11). The controlling part 140 performs such a calculation process with respect to every point of the target object 103 to be heated.

The controlling part 140 emits microwaves from the microwave generators M1 to M8 in step S4. The electric filed intensities of the microwaves emitted from the respective microwave generators M1 to M8 are the electric field intensities EM1 to EM8 represented by the formulas (10).

A time during which the microwaves are emitted may be a set time if it is set by a user. In case where the time is not set by a user, the time may be determined based on a target temperature, a type of the target object 103 to be heated, outputs (electric powers) of the microwaves that are output from the microwave generators M1 to M8, and the like.

The controlling part 140 causes the PARs 110X and 110Z to emit the millimeter waves and to scan their angles, and obtains an intensity distribution of the millimeter waves from the receiving arrays 120X and 120Z in step S5. This process is similar to the process of steps S1 and S2. This is in order to obtain, after emitting the microwaves, a three-dimensional distribution of a frozen portion 103A and an unfrozen portion 103B of the target object 103B to be heated.

The controlling part 140 determines whether a frozen portion 103A is present in step S6. This is in order to determine whether a heating process is still required.

Upon determining that a frozen portion 103A is present (YES in step S6), the controlling part 140 returns the flow to step S3. This is in order to calculate the electric field intensities of the microwaves to again heat the target object 103 to be heated.

Conversely, upon determining that a frozen portion 103A is not present (NO in step S6), the controlling part 140 turns off the heating mode. Then, the controlling part 140 completes the flow (END). The process is finished because the heating is completed.

As described above, according to the first embodiment, it is possible to detect, based on the distribution of the frozen portion 103A and the unfrozen portion 103B of the target object 103 to be heated in the XZ plane, and based on the distribution of the frozen portion 103A and the unfrozen portion 103B of the target object 103 to be heated in the XY plane, the three-dimensional distribution of the frozen portion 103A and the unfrozen portion 103B of the target object 103 to be heated can be detected. This effect is obtained by a detecting apparatus according to the first embodiment.

Further, according to the first embodiment, based on the three-dimensional distribution of the frozen portion 103A and the unfrozen portion 103B of the target object 103 to be heated, the electric field intensities at the points P (X,Y,Z) are obtained and the microwaves are emitted from the microwave generators M1 to M8. Therefore, in accordance with the three-dimensional distribution of the frozen portion 103A and the unfrozen portion 103B, the target object 103 to be heated can be heated (defrosted).

Note that the points P (X,Y,Z) may be set in advance such that the points P (X,Y,Z) are three-dimensionally arranged, inside the heat chamber 101, at a predetermined interval. For example, in a case where the predetermined interval is 10 mm, a plurality of points P (X,Y,Z) are arranged at 10 mm intervals in the X axis direction, the Y axis direction, and the Z axis direction inside the heat chamber 101. Then, a distribution of the frozen portion 103A and the unfrozen portion 103B may be detected with respect to the plurality of points P (X,Y,Z) to set electric field intensities of the microwaves emitted from the microwave generators M1 to M8.

As described above, according to the first embodiment, it becomes possible to provide the detecting apparatus and the heating apparatus 100 that can detect a distribution of amounts of heat required in a target object to be heated.

In other words, the heating apparatus 100 may control, based on a distribution of intensities of the millimeter waves received by the receiving array 120X and based on a distribution of intensities of the millimeter waves received by the receiving array 120Z, the microwave generators M1 to M8 such that the outputs of the respective microwaves increase with decreasing intensities at regions and the outputs of the respective microwaves decrease with decreasing intensities at regions. Further, the heating apparatus 100 may control the microwave generators M1 to M8 such that the phases of the microwaves are equal to each other at a position at which the target object 103 to be heated is located.

Note that although the PARs 110X and 110Z and the receiving arrays 120X and 120Z are used to obtain a three-dimensional intensity distribution of the millimeter waves in the embodiment described above, the PAR 110X and the receiving array 120X or and the PAR 110Z and the receiving array 120Z may be used to obtain a three-dimensional intensity distribution. If a two-dimensional distribution of the frozen portion 103A and the unfrozen portion 103B is obtained, the target object 103 to be heated can be efficiently heated relative to a case without a distribution.

### Second Embodiment

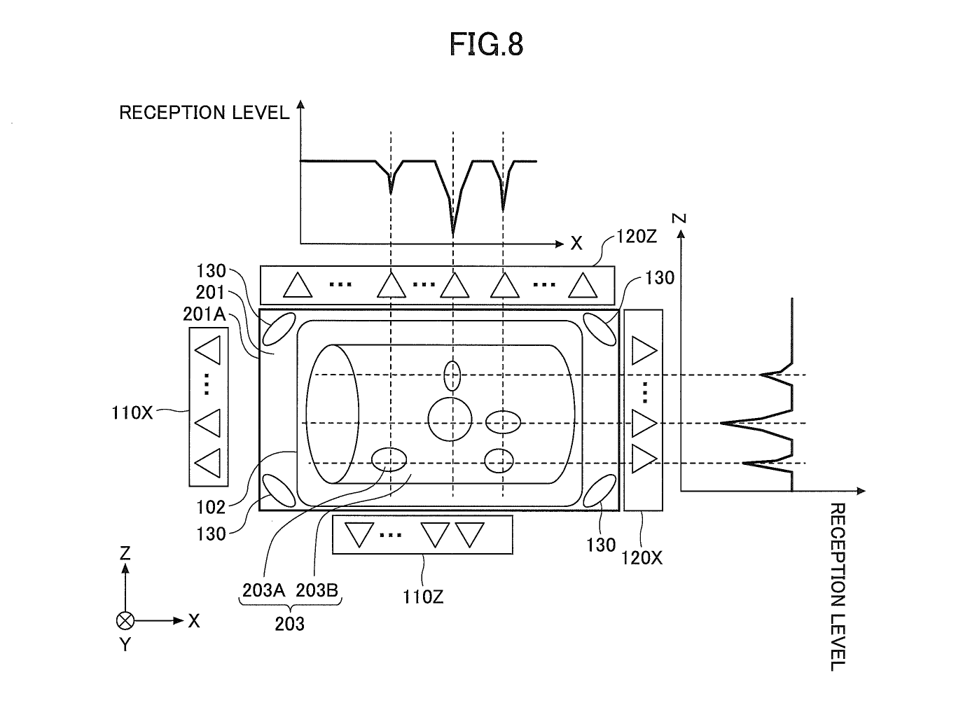

FIG. 8 is a diagram illustrating a heating apparatus 200 according to a second embodiment. Although the heating apparatus 100 according to the first embodiment heats the target object 103 to be heated that includes the frozen portion 103A and the unfrozen portion 103B, the heating apparatus 200 according to the second embodiment heats a Diesel particulate filter (DPF) 203 as a target object to be heated.

The DPF 203 is an apparatus that purifies exhaust gas of a diesel engine and is inserted in series in an exhaust pipe for emitting the exhaust gas of the diesel engine. Because soot included in the exhaust gas adheres to the DPF 203, the DPF 203 performs a heating process (regeneration process) to remove the soot at a predetermined frequency (for example, regularly).

According to the second embodiment, the heating apparatus 200 heats the DPF 203 as a target object to be heated, and breaks down the soot adhering to the DPF 203 by energy of microwaves. According to the second embodiment, millimeter waves of 22 GHz emitted by the PARs 110X and 110Z are used as millimeter waves in a frequency band reflected by the soot adhering to the DPF 203.

Upon emitting the millimeter waves from the PARs 110X and 110Z to the DPF 203, the millimeter waves are reflected more at a portion 203A at which soot is present than at a portion 203B at which soot is not present. Therefore, the intensities of the millimeter waves received by the receiving arrays 120X and 120Z decrease. This is the same as a decrease of the intensity of the millimeter wave at the frozen portion 103A.

Accordingly, based on a three-dimensional distribution of the millimeter waves obtained based on intensities of the millimeter waves received by the receiving arrays 120X and 120Z, electric field intensities of the microwaves emitted from the microwave generators 130 may be determined.

As described above, according to the second embodiment, based on a three-dimensional distribution of a portion 203A, at which soot is present, and a portion 203B, at which soot is not present, of the DPF 203, electric field intensities at points P (X,Y,Z) of the DPF 203 are obtained to emit the microwaves from the eight microwave generators 130 (similar to the microwave generators M1 to M8 according to the first embodiment). Thereby, in accordance with the three-dimensional distribution of the portion 203A, at which soot is present, and the portion 203B, at which soot is not present, the DPF 203 can be heated and a regeneration process of the DPF 203 can be performed.

Therefore, according to the second embodiment, it becomes possible to provide the detecting apparatus and the heating apparatus 200 that can detect a distribution of amounts of heat required in the DPF 203.

Further, the embodiment may be as follows.

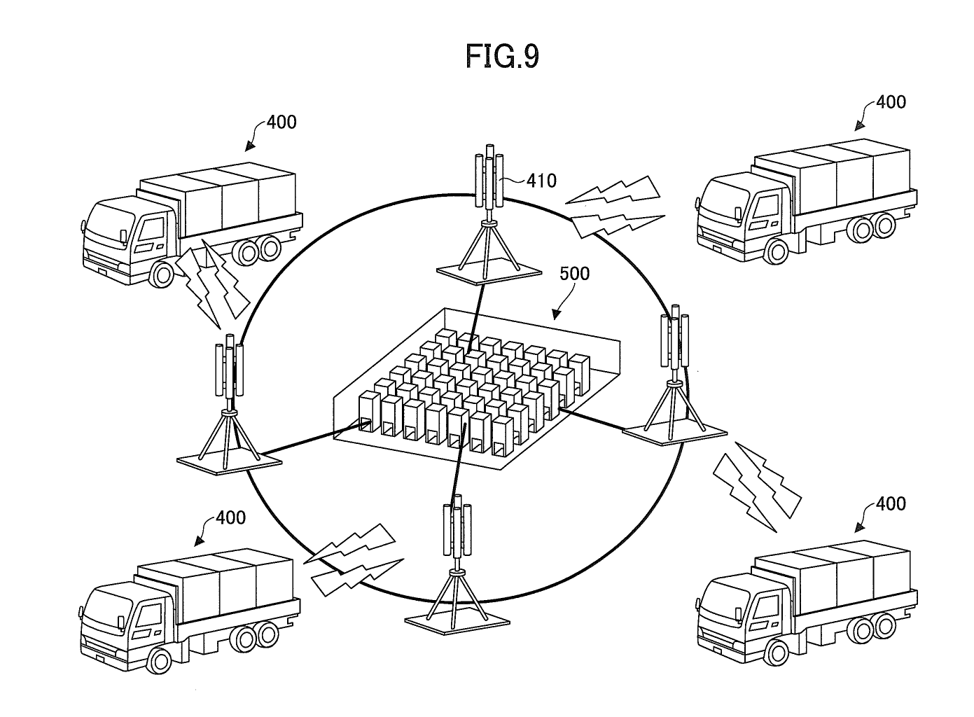

FIG. 9 is a diagram illustrating an operation control system including an information processing apparatus 500 of a data center. The information processing apparatus 500 of the data center is able to wirelessly communicate with vehicles 400 via wireless base stations 410. For example, the wireless base stations 410 are base stations (relay stations) for wireless communications using mobile telephone lines. Such an image forming apparatus 500 at a data center may be a server or may be a virtual machine (cloud computer, for example) realized by a plurality of servers or computers.

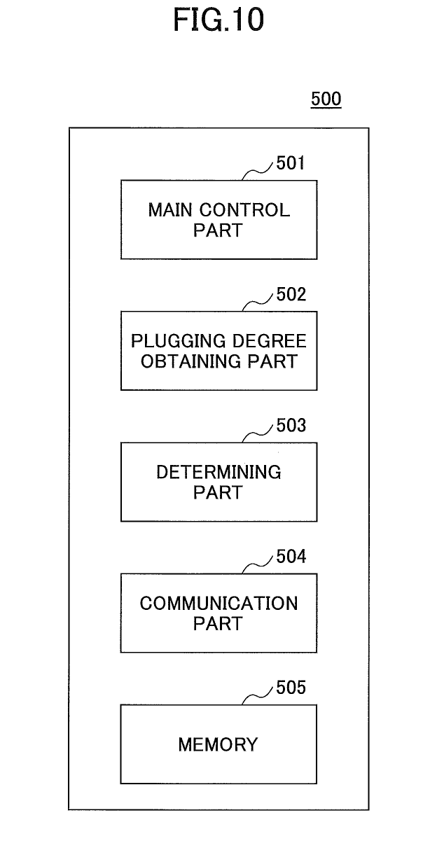

FIG. 10 is a block diagram illustrating a configuration of the information processing apparatus 500. The information processing apparatus 500 includes a main control part 501, a plugging degree obtaining part 502, a determining part 503, a communication part 504, and a memory 505.

In the following, the receiving arrays 120X and 120Z are referred to as antennas 120.

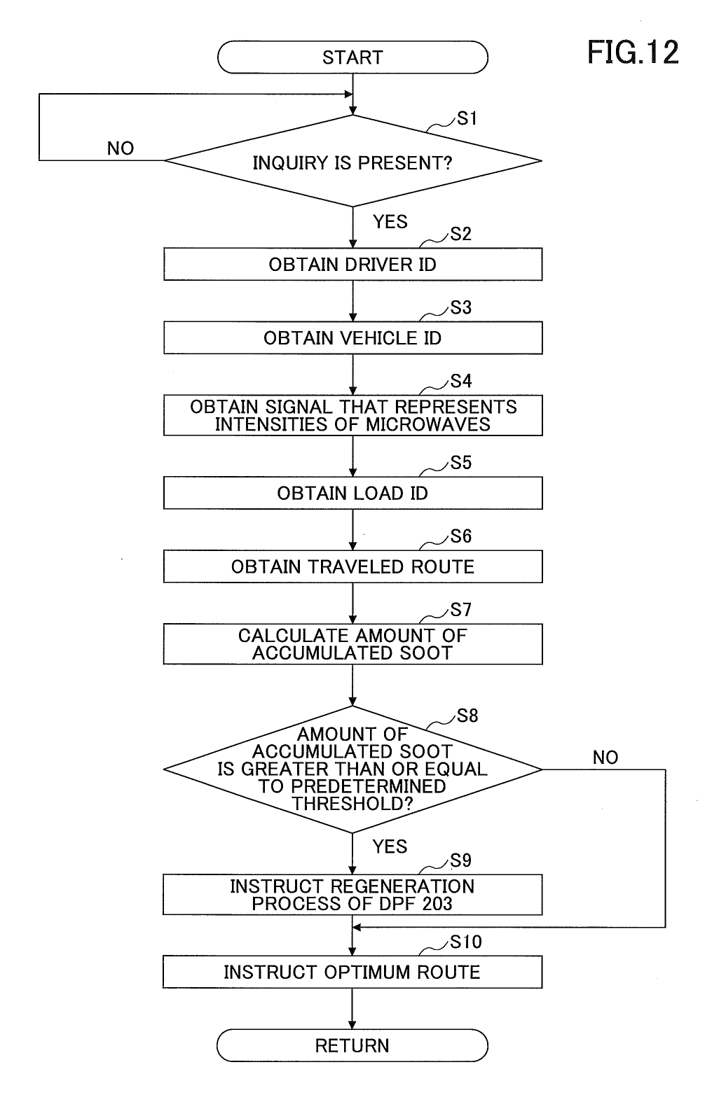

The main controlling part 501 is a processor that controls a process of the information processing apparatus 500, and communicates with the vehicle 400 to perform a predetermined process such as transmitting, to an ECU 300 of the vehicle 400 via the communication part 504, a command signal to execute the reproduction process of the DPF 203 in accordance with an amount of accumulated soot, a type of a load, a route that has been traveled, and the like. A specific process that is executed by the main controlling part 501 will be described later below with reference to a flowchart of FIG. 12.

The plugging degree obtaining part 502 wirelessly obtains, from the ECU 300 of the vehicle 400 through the communication part 504, a signal that represents a degree of plugging detected by the antennas 120 used as sensors that detects the degree of plugging. The degree of plugging (clogging) is represented by intensities of the microwaves received by the antennas 120.

The determining part 503 calculates an amount of accumulated soot of the DPF 203 based on the signal that represents the degree of plugging (the signal that represents intensities of the microwaves) obtained by the plugging degree obtaining part 502. The amount of accumulated soot of the DPF 203 can be calculated based on a ratio of the intensities of the microwaves received by the antennas 120 to the intensities of the microwaves emitted from the antennas 120 to the DPF 203.

The determining part 503 uses previously stored data, which represents the intensities of the microwaves output from the antennas 120 to the DPF 203, to obtain the ratio with respect to the degree of plugging (the intensities of the microwaves received by the antennas 120) to calculate the amount of accumulated soot of the DPF 203.

The amount of accumulated soot decreases as a ratio of the intensities of the microwaves received by the antennas 120 to the intensities of the microwaves output from the antennas 120 to the DPF 203 decreases, and the amount of accumulated soot increases as the ratio increases. This is because, when the amount of accumulated soot is small, the microwaves are not substantially reflected by the DPF 203, and when the amount of accumulated soot is large, the degree of the microwaves reflected by the DPF 203 increases.

Note that by determining a relationship between ratios of the intensities of the microwaves received by the antennas 120 to the intensities of the microwaves output from the antennas 120 to the DPF 203 and amounts of accumulated soot in advance through experiments, simulations, or the like, a specific amount of accumulated soot can be obtained from a ratio of the intensities of the received microwaves to the intensities of the output microwaves.

The determining part 503 determines whether a calculated degree of plugging is greater than or equal to a predetermined threshold degree. Upon determining that the degree of plugging is greater than or equal to the predetermined threshold degree, the determining part 503 causes the main controlling part 501 to execute a process of transmitting a command signal to the ECU 300 of the vehicle 400 in order to cause the ECU 300 to execute the regeneration process of the DPF 203.

The communication part 504 wirelessly communicates with the ECUs 300 of the vehicles 400 through wireless communication using mobile telephone lines. The communication part 504 is a modem. Further, the memory 505 stores various kinds of data such as data required for processes to be performed in the data center.

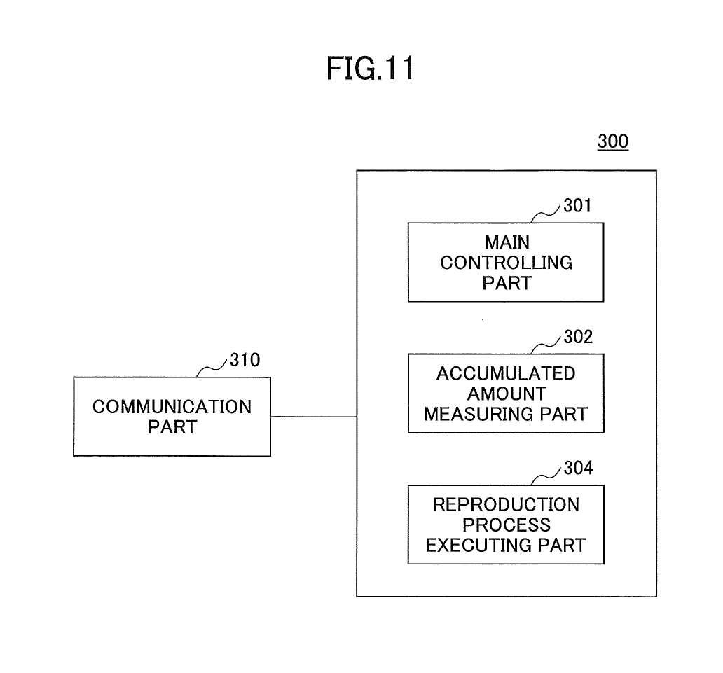

FIG. 11 is a block diagram illustrating a configuration of the ECU 300.

The ECU 300 includes a main controlling part 301, an accumulated amount measuring part 302, and a regeneration process executing part 304. The ECU 300 is coupled to a communication part 310. The communication part 310 is a modem that is mounted on the vehicle 400 and wirelessly communicates with the communication part 504 of the information processing apparatus 500 through wireless communication using portable telephone lines.

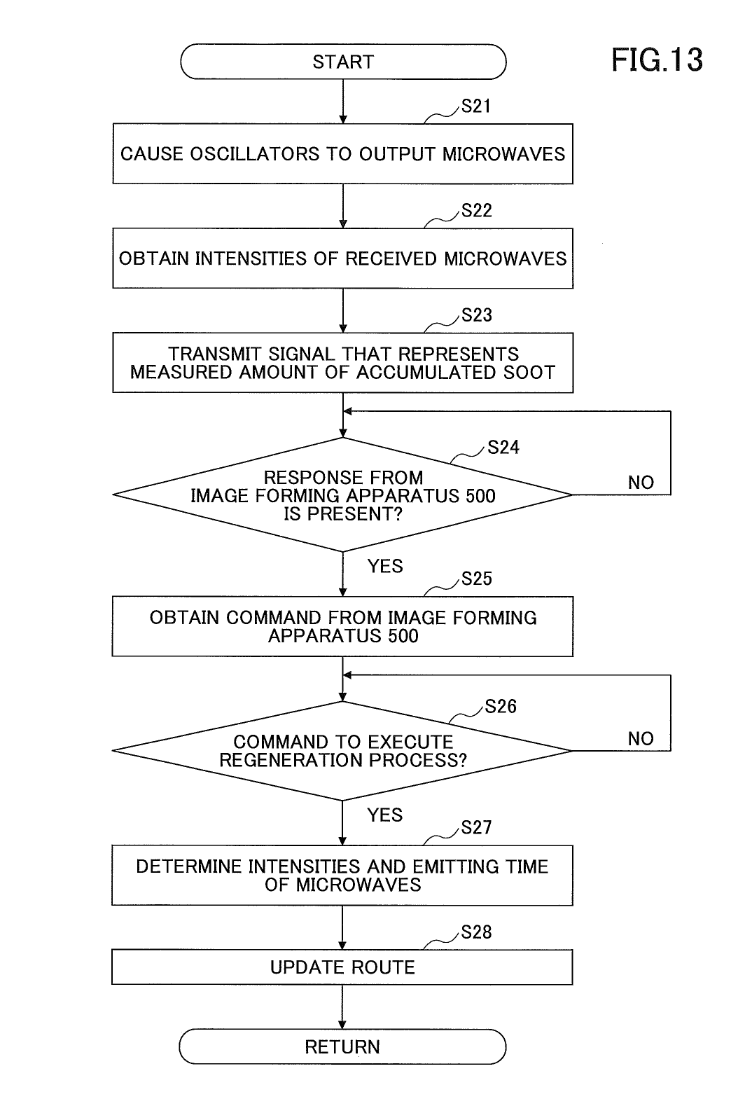

The main controlling part 301 is a processor that controls a process of the ECU 300 and executes various processes via a controlling part. A specific process that is executed by the main controlling part 301 will be described later below with reference to a flowchart of FIG. 13.

In response to a command from the information processing apparatus 500, the accumulated amount measuring part 302 radiates microwaves for measurement from the antennas 120 to the DPF 203 via the controlling part and obtains intensities of the microwaves received by the antennas 120. The accumulated amount measuring part 302 transmits, to the information processing apparatus 500, a signal that represents the obtained intensities of the microwaves. The signal that represents the obtained intensities of the microwaves is used when calculating an amount of soot accumulated in the DPF 203 (a degree of plugging of the DPF 203).

In response to a command from the information processing apparatus 500, the regeneration process executing part 304 performs a regeneration process of the DPF 203 via the controlling part. Based on the obtained amount of soot, the regeneration process executing part 304 determines intensities and an emission time of the microwaves for heating/incinerating the soot (for performing a regeneration process).

FIG. 12 is a flowchart illustrating a process that is executed by the information processing apparatus 500. This process is executed by the main controlling part 501, the plugging degree obtaining part 502, the determining part 503, and the communication part 504.

Upon starting the process (START), the main controlling part 501 checks in step S1 whether an inquiry from a vehicle 400 is present. An inquiry from a vehicle 400 is made to the information processing apparatus 500 when the ECU 300 of the vehicle 400 executes a regeneration process. The process of step S1 is repeatedly executed until the main controlling part 501 detects the presence of an inquiry.

The main controlling part 501 obtains a driver Identification (ID) in step S2. The driver ID is transmitted from the ECU 300 of the vehicle 400 to the information processing apparatus 500 when the vehicle 400 transmits the inquiry to the information processing apparatus 500.

The main controlling part 501 reads out data that represents a driving pattern associated with the driver ID in a database.

The main controlling part 501 obtains a vehicle ID in step S3. The vehicle ID is transmitted from the ECU 300 of the vehicle 400 to the information processing apparatus 500 when the vehicle 400 transmits the inquiry to the information processing apparatus 500.

The plugging degree obtaining part 502 obtains in step S4 a signal that represents intensities of microwaves transmitted from the vehicle 400. The signal representing the intensities of the microwaves is a signal representing the degree of plugging of the DPF 203, which is used in calculating the amount of soot accumulated in the DPF 203.

The main controlling part 501 obtains a load ID in step S5. The load ID is transmitted from the ECU 300 of the vehicle 400 to the information processing apparatus 500 when the vehicle 400 transmits the inquiry to the information processing apparatus 500. The load ID represents a type of a load loaded on the vehicle 400.

The main controlling part 501 obtains in step S6 a traveled route. The traveled route is a history of roads on which the vehicle 400 subject to being processed in the flow illustrated in FIG. 12 has traveled by the time of inquiry. Such a traveled route may be obtained by, for example, periodically conducting communication between the ECU 300 of the vehicle 400 and the information processing apparatus 500 to acquire, from a navigation system of the vehicle 400, data representing the roads on which the vehicle 400 has been traveling.

The determining part 503 calculates an amount of accumulated soot of the DPF 203 in step S7. Based on the signal that represents the intensities of the microwaves, the determining part 503 calculates the amount of accumulated soot of the DPF 203.

The determining part 503 determines in step S8 whether the amount of accumulated soot is greater than or equal to a predetermined threshold value. The predetermined threshold value may be stored in advance by the information processing apparatus 500 in the memory 505.

Upon determining that the amount of accumulated soot is greater than or equal to the predetermined threshold value (YES in step S8), the main controlling part 501 instructs the ECU 300 of the vehicle 400 to execute a regeneration process of the DPF 203 in step S9.

The main controlling part 501 instructs an optimum route in step S10. The optimum route indicates the most suitable route for performing a regeneration process among the routes to a current destination that may be taken by the vehicle 400 when the vehicle 400 performs the regeneration process. A route suitable for performing the regeneration process may, for example, be a route that facilitates continuous traveling of the vehicle 400 at a constant speed such as an expressway or freeway.

Upon completing the above process, the main controlling part 501 returns the flow to step S1. Because the information processing apparatus 500 communicates with a plurality of vehicles 400, every time an inquiry is transmitted from any vehicle 400, the information processing apparatus executes the process illustrated in FIG. 12.

FIG. 13 is a flowchart illustrating a process that is executed by the ECU 300. The following process is executed by the ECU 300 via the controlling part.

The main controlling part 301 starts the process at a predetermined timing to cause oscillators for measuring the accumulated amount to output microwaves in step S21. The predetermined timing is, for example, when the travel distance of the vehicle 400 reaches a predetermined distance after the previous regeneration process, or when the fuel injection amount reaches a predetermined amount, or the like. Note that because the regeneration process of the DPF 203 may be conducted substantially periodically, the method of taking the predetermined timing may be a method other than those described above.

In step S22, the accumulated amount measuring part 302 emits the microwaves for measuring the accumulated amount to obtain intensities of the microwaves received from the antennas 120. The signal representing the intensities of the microwaves is a signal representing the degree of plugging of the DPF 203, which is used in calculating the amount of soot accumulated in the DPF 203.

The main controlling part 301 transmits, to the information processing apparatus 500 of the data center in step S23, a signal that represents the measured amount of accumulated soot.

The main controlling part 301 determines whether a response from the image forming apparatus 500 of the data center is present in step S24. The process of step S24 is repeatedly executed until the main controlling part 301 receives a response from the information processing apparatus 500.

Upon receiving a response (YES in step S24), the main controlling part 301 obtains a command from the image forming apparatus 500 of the data center in step S25.

The main controlling part 301 determines in step S26 whether the command obtained in step S25 is a command to execute the regeneration process. The process of step S26 is repeatedly executed until the main controlling part 301 determines that the command obtained in step S25 is a command to execute the regeneration process.

The regeneration process executing part 304 determines in step S27 the intensities and the emission time of the microwaves for heating/incinerating the soot (for performing a regeneration process) based on the obtained amount of accumulated soot.

The main controlling part 301 updates the route in step S28).

Upon completing the above described process, the main controlling part 301 returns the flow to step S1.

As described above, according to the embodiment, the microwaves are directly emitted from the antennas 120 disposed inside convex portions of the pipe to the DPF 203 disposed inside the pipe. Therefore, the structure of the exhaust gas treatment apparatus may be simplified. The exhaust gas treatment apparatus includes a filter regeneration device and a filter plugging detection device, and a filter plugging determination method is performed using the exhaust gas treatment apparatus.

Therefore, according to the embodiment, it becomes possible to provide, with a simple structure, a filter regeneration device, a filter plugging detection device, the exhaust gas treatment apparatus, and a filter plugging determination method.

In addition, because the antennas 120 are disposed inside the convex portions where the outer peripheral portion of the pipe protrudes outward, the antennas 120 deviate from the flow path of the exhaust gas. As a result, the antennas 120 will not interfere with the flow of the exhaust gas, which makes the antennas 120 less susceptible to being heated by the exhaust gas, less susceptible to breakage, or the like, thereby extending the life of the antennas 120.

Further, because the amount of accumulated soot can be obtained based on the ratio of the intensities of the microwaves received by the antennas 120 to the intensities of the microwaves output from the antennas 120 to the DPF 203, the intensities of the microwaves may be determined according to the amount of accumulated soot at the time of regenerating the DPF 203.

Further, because a GaN-HEMT is used as a transistor, the microwaves generated in the oscillators may be amplified to high-power microwaves.

The method implemented by the flows of FIG. 12 and FIG. 13 is a filter plugging determination method. According to the embodiment described above, the determining part 503 of the information processing apparatus 500 determines whether the amount of accumulated soot is equal to or greater than the predetermined threshold value. However, the ECU 300 may compare the amount of accumulated soot with a predetermined threshold value to make such a determination.

Further, according to the embodiment described above, in order to measure the amount of accumulated soot, the microwaves are radiated from the antennas 120 and the microwaves reflected by the DPF 203 are received. Alternatively, other antennas may be provided on the sides opposite to the antennas 120 with the DPF 203 to be interposed between the two antennas, and the microwaves radiated from the antennas 120 and that have passed through the DPF 203 may be received by the other antennas. In this case, as the intensities of the received microwaves increase, the amount of accumulated soot decreases; and, as the intensities of the received microwaves decrease, the amount of accumulated soot increases.

Although the antennas 120 are monopole antennas in the embodiment described above, the antennas 120 may be any type of antennas such as dipole antennas or patch antennas.

Further, the shapes of the convex portions on which the antennas 120 are disposed are not limited to a hemispherical shape, and may be any shapes insofar as the shapes do not interfere with the radiation and reception of microwaves.

Although examples of a detecting apparatus and a heating apparatus according to the embodiments of the present invention have been described above, the present invention is not limited to the embodiments specifically disclosed and various variations and modifications may be made without departing from the scope of the present invention.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. A detecting apparatus comprising:
a plurality of first emitting parts two-dimensionally disposed, in a first axial direction with respect to an arrangement position at which a target object to which millimeter waves are to be emitted is arranged, to be directed to the arrangement position, the plurality of first emitting parts being configured to emit millimeter waves having a wavelength that is absorbed or reflected by a specific substance included in the target object;
a first receiving part two-dimensionally disposed to face the plurality of first emitting parts across the arrangement position and to be directed to the arrangement position, the first receiving part being configured to receive the millimeter waves; and
a first detecting part configured to detect a two-dimensional intensity distribution of the millimeter waves received by the first receiving part.

2. The detecting apparatus according to claim 1, further comprising:
a plurality of second emitting parts two-dimensionally disposed, in a second axial direction with respect to the arrangement position, to be directed to the arrangement position, the plurality of second emitting parts being configured to emit millimeter waves having a wavelength that is absorbed or reflected by the specific substance included in the target object;
a second receiving part two-dimensionally disposed to face the plurality of second emitting parts across the arrangement position and to be directed to the arrangement position, the second receiving part being configured to receive the millimeter waves emitted from the plurality of second emitting parts; and
a second detecting part configured to detect a two-dimensional intensity distribution of the millimeter waves received by the second receiving part.

3. A heating apparatus comprising:
a plurality of first emitting parts two-dimensionally disposed, in a first axial direction with respect to an arrangement position at which a target object to which millimeter waves are to be emitted is arranged, to be directed to the arrangement position, the plurality of first emitting parts being configured to emit millimeter waves having a wavelength that is absorbed or reflected by a specific substance included in the target object;
a first receiving part two-dimensionally disposed to face the plurality of first emitting parts across the arrangement position and to be directed to the arrangement position, the first receiving part being configured to receive the millimeter waves;
a first detecting part configured to detect a first two-dimensional intensity distribution of the millimeter waves received by the first receiving part;
at least one microwave emitting part configured to emit a microwave to the arrangement position; and
an output controlling part configured to control, based on the first intensity distribution detected by the first detecting part, an output of the microwave emitted from the least one microwave emitting part such that the output of the microwave increases with decreasing an intensity at a region and the output of the microwave decreases with decreasing an intensity at a region.

4. The heating apparatus according to claim 3, further comprising:
a plurality of second emitting parts two-dimensionally disposed, in a second axial direction with respect to the arrangement position, to be directed to the arrangement position, the plurality of second emitting parts being configured to emit millimeter waves having a wavelength that is absorbed or reflected by the specific substance included in the target object;
a second receiving part two-dimensionally disposed to face the plurality of second emitting parts across the arrangement position and to be directed to the arrangement position, the second receiving part being configured to receive the millimeter waves emitted from the plurality of second emitting parts; and
a second detecting part configured to detect a second two-dimensional intensity distribution of the millimeter waves received by the second receiving part,
wherein the output controlling part configured to control, based on the first intensity distribution and the second intensity distribution detected by the first detecting part and the second detecting part, the output of the microwave emitted from the at least one microwave emitting part such that the output of the microwave increases with decreasing an intensity at a region and the output of the microwave decreases with decreasing an intensity at a region.

5. The heating apparatus according to claim 4,
wherein the at least one microwave emitting part includes a plurality of microwave emitting parts configured to emit microwaves, and
wherein the output controlling part controls, based on the first intensity distribution and the second intensity distribution, the plurality of microwave emitting parts such that phases of the microwaves emitted from the plurality of microwave emitting parts are equal to each other at a position at which the specific substance is present.
